(19) United States
(12) Patent Application Publication
(10) Pub. No.: US 2008/0067178 A1
(43) Pub. Date: Mar. 20, 2008

(54) Portable tank and tank container for liquefied gas transportation

(75) Inventors: Hongli Sun, Shenzhen (CN); Yongxin Luo, Shenzhen (CN); Xiaohu Yang, Shenzhen (CN)

Correspondence Address: GREER, BURNS & CRAIN, 300 S WACKER DR, 25TH FLOOR, CHICAGO, IL, 60606, US

(73) Assignee: POLYEARN DEVELOPMENT CORPORATION

(21) Appl. No.: 11/900,471

(22) Filed: Sep. 12, 2007

(30) Foreign Application Priority Data
Sep. 15, 2006 (CN) 200620137134.9

(51) Int. Cl. F17C 1/00

(52) U.S. Cl. 220/560.04

(57) ABSTRACT

A tank container for transporting and storing liquefied gas, including a tank that includes a cylinder body and two heads arranged oppositely and welded with both ends of the cylinder body; and a frame assembly for fixing and supporting said tank, which includes a front frame and a rear frame fixed at both ends of said tank respectively. The cylinder body has a shell thickness δ substantially equal to: P_{c}×Dᵢ/(2σ_{b}/Kₛ−P_{c}), wherein, P_{c} is the calculated pressure of the tank, required by the transported liquefied gas, Dᵢ is the inner diameter of the cylinder body, σ_{b} is the maximum tensile strength of material of the cylinder body at a normal temperature, and Kₛ is a safety factor no larger than 2.6. The tank container is designed through stress analysis methods, the safeness of which has been verified.

### FIELD OF THE INVENTION

The present invention relates to a portable pressurized vessel, in particular to an ultra-light tank for liquefied gas transportation and a tank container with said tank.

### BACKGROUND OF THE INVENTION

In general, bulk cargos are divided into solid power bulk cargos, liquid bulk cargos and gas bulk cargos, in which some gas bulk cargos can be converted into liquefied status under a predetermined pressure. Gas in the form of liquid under high pressures is referred to as liquefied gas. Compared with the gas under normal pressures, the liquefied gas can be transported and stored more efficiently for its smaller volume.

In the technical field of bulk cargo transportation, transporting equipments, such as railway tank trucks, highway tank trucks, tank containers and packed barrels, and storage equipments, such as fixed storage tanks etc, are often used. Tank container is equipment suitable for transportation by highway, railway and sea, and for storage. The International Standardization Organization (ISO) has put concrete requirements and regulations on the design, calculation, manufacture, testing, utilization and operation of tank container. For example, International Standard IS01496-3 has put technical requirements and conditions on the containers for transporting liquid, gas and dry bulk cargos, respectively.

At normal temperatures, liquefied gas is formed by exerting a high pressure on the gas, which is therefore of danger during transportation and storage stages. Various countries have put relevant standards, codes and/or special ratifications for the design, manufacture and utilization of the equipments for transporting and/or storing liquefied gas, for example, the American Society of Mechanical Engineers (ASME) Boiler and Pressure Vessel Code and the approval by the Department of Transportation (D.O.T.) in the United State, the EU Pressurized Equipment Directive (PED) in Europe, the Pressure Vessels Safety and Technical Supervision Regulation and the National Standard GB150: Steel Pressure Vessel in China, etc.

The storage volume of the liquefied gas tank in single transportation is determined by the deadweight and the inner volume of the tank container. In the case that the rated mass of the tank is not limited, the larger the inner volume is the more cargos the tank container contain can transport. However, the rated mass of the container is limited by relevant standard, such as International Standard IS0688 that stipulates the types, outer sizes and rated mass of the containers. Hence, no more cargos can be transported even the inner volume becomes larger, and the smaller the tank's deadweight, the more the transported cargos. The objective of the design for liquefied gas tank container is therefore to minimize the deadweight of the transportation equipment.

The tank container for liquefied gas is usually composed of a tank having a cylinder body and two heads on opposite ends of the cylinder body, and a frame for supporting said tank. The tank is a component for enduring pressures and the calculation of its thickness is therefore restricted by various standards in various countries. For example, according to Chinese National Standard GB150: Steel Pressure Vessel, the shell thickness a of the cylinder body of the tank is calculated by the equation:

δ=P_{c}×Dᵢ/(2[σ]^{T}×Φ=P_{c})

where
P_{c} is the calculated pressure;
Dᵢ is the inner diameter of the cylinder body;
[σ]^{T} is the allowable stress; and
Φ is the welded joint factor.
   For another example, according to Chinese Technical Standard JB4732: Steel Pressure Vessel—Standards for Analysis and Design, the shell thickness δ is calculated by the following equation:

δ=P_{c}×Dᵢ/(2K×Sₘ−P_{c})

where, K is the combined load coefficient; and

Sₘ is the designed stress strength.

It can be seen that the calculated thickness δ is only determined by the allowable stress [σ]^{T} or the designed stress strength Sₘ when the calculated pressure P_{c}, the inner diameter Dᵢ of the cylinder body, the welded joint factor Φ and the combined load coefficient K are determined. The allowable stress [σ]^{T}, as well as the designed stress strength Sₘ, is relevant to a product of the maximum tensile strength σ_{b} of the materiel of the cylinder body at a normal temperature and the reciprocal of a safety factor Kₛ.

In general, according to the Pressure Vessels Safety and Technical Supervision Regulation, the National Standard GB150 and the Liquefied Gas Tank Container that are adopted by China, and according to the Section VIII, Division 1, of the ASME boiler and Pressure Vessel Code that is adopted by the U.S. D.O.T., the thickness δ of the cylinder body can be all considered as

δ=P_{c}×Dᵢ(2σ_{b}/Kₛ−P_{c})

where
P_{c} is the calculated pressure;
Dᵢ is the inner diameter of the cylinder body;
σ_{b} is the maximum tensile strength of material of the cylinder body at a normal temperature; and
Kₛ is the safety factor.

It is evident that the thickness of the shell of the cylinder body, which is a main cause of the deadweight of the tank, is determined by the values of both the maximum tensile strength σ_{b} of the material of the cylinder body at a normal temperature and the safety factor Kₛ. When a certain material is selected, the larger the safety factor Kₛ, the larger the cylinder body wall thickness, and the larger the tank deadweight, and vice versa.

The value of safety factor Kₛ can be different according to different standards or codes. According to Section VIII, Division 1, of the ASME boiler and Pressure Vessel Code, the safety factor Kₛ is taken as 3.5, while according to Section VIII, Division 2, of the ASME boiler and Pressure Vessel Code, the safety factor Kₛ is taken as 3.0. According to the criterions in Chinese National Standard GB150 or in the Liquefied Gas Tank Containers in China, the safety factor Kₛ is taken as 3.0. The U.S. Pat. No. 6,012,598 discloses a tank container 10 comprising a tank 12 and a frame 14, wherein the shell of the cylinder body 24 of the tank has a thickness equal to P Rᵢ/(⅓Sᵤ−0.5P), which is equivalent to the thickness δ calculated as δ=P_{c}×Dᵢ/(2σ_{b}/Kₛ−P_{c}) with a safety factor Kₛ of 3.0.

Chinese Technical Standard JB4732: Steel Pressure Vessel—Standard for Analysis and Design stipulates the methods for designing and manufacturing vessels for liquefied gas storage by using stress analysis. According to this technical standard, the shell thickness δ of the cylinder body is calculated as P_{c}×Dᵢ/(2σ_{b}/Kₛ−P_{c}) with a safety factor Kₛ of 2.6. This technical standard, however, makes it clear that it does not suitable to vessels often moved. Therefore, there is no tank container product having a shell thickness calculated as P_{c}×Dᵢ/(2σ_{b}/Kₛ−P_{c}) with a safety factor K, less than 2.6 as yet.

It is noteworthy that the above-mentioned standards and codes are not permanent, and are subject to change with the development of related techniques. It is therefore an objective of the industrial customers to produce a tank container which can meet the requirements on safety while reducing its deadweight.

In addition, as shown in FIG. 1, the tank container 10 disclosed in U.S. Pat. No. 6,012,598 includes the tank 12, the frame 14 for fixing said tank 12, a safety attachment 44, an adumbral plate 72, and a corner member 60 for lifting and stacking, etc. Said tank 12 is formed by welding the cylinder body 24 with two sealing head 26, and the thickness of the head 26 is larger than that of the cylinder body 24. Said frame 14 includes two ends arranged at the ends of the tank 12 respectively, and two upper and two lower rails 54 arranged on both side of the tank 12, and connecting directly between the two ends of the frame for transferring loads. The tank 12 and the ends of the frame are welded together through neck rings 58 having a diameter similar to that of the cylinder body 24. The tank container of this structure, however, is of larger deadweight and will lead to a decrease in loaded cargos due to the restriction by related criterions to the rated mass of the container.

### SUMMARY OF THE INVENTION

It is the objective of the invention to provide a portable tank and a tank container for transporting and/or storing liquefied gas, which have a decreased deadweight while meeting safety requirements.

According to one aspect of the present invention, the objective is realized by providing a portable tank, in particular an ultra-light one, for liquefied gas transportation and storage, which includes a cylinder body and two heads arranged oppositely and welded with both ends of the cylinder body respectively. The cylinder body has a shell thickness δ calculated through stress analysis design methods for fixed containers, and substantially equal to: P_{c}×Dᵢ/(2σ_{b}/Kₛ−P_{c}), wherein, P_{c} is the calculated pressure of the tank according to the transported liquefied gas; Dᵢ is the inner diameter of the cylinder body; σ_{b} is the maximum tensile strength of material of the cylinder body at a normal temperature; and Kₛ is a safety factor that is no larger than 2.6.

According to another aspect of the present invention, the objective of the invention is realized by providing a tank container for liquefied gas transportation and storage, in particular a ultra-light one, which includes a tank comprising a cylinder body and two heads arranged oppositely and connected with both ends of the cylinder body respectively; and a frame assembly for fixing and supporting said tank, and comprising a front frame and a rear frame fixed at both ends of said tank respectively. Said front and rear frames are formed by welding steel structures with sufficient strength, and are connected with the tank through solid connection such as welding with neck rings, said frame assemble is provided with eight container corner members on eight end corners, respectively, for operations such as fastening and hoisting. Said tank is formed by welding together the heads, the cylinder body and preferably a safety attachment and etc. According to the property of the liquefied gas to be stored and transported, the cylinder body is designed to have a shell thickness δ substantially equal to P_{c}×Dᵢ/(2σ_{b}/Kₛ−P_{c}, wherein P_{c} is the calculated pressure of the tank according to the transported liquefied gas; Dᵢ is the inner diameter of the cylinder body; σ_{b} is the maximum tensile strength of material of the cylinder body at a normal temperature; and Kₛ is a safety factor that is no larger than 2.6. Preferably, the tank is made from a material having a maximum tensile strength σ_{b} no less than 470 MPa.

According to the present invention, with the same material, the cylinder body can have a smaller thickness that is calculated with a safety factor Ks of no larger than 2.6 than that of the cylinder body currently used, so that the tank can have a relatively light deadweight.

According to also another aspect of the present invention, the heads are designed with an ellipticity of 1:1.9 and through stress analysis methods, so as to obtain a thickness less than or equal to the thickness of the cylinder body thickness. With the same design condition for the cylinder body, the deadweight of the tank according to the present invention can be further reduced through the reduced thickness of the heads.

According to still another aspect of the present invention, the frame assembly of the invention is designed without the upper and lower rails that are commonly used for supporting the front and rear frames in a tank container. The tank, especially the cylinder body, is taken as the member for transferring loads. In particular, the load received by one frame is transferred to the cylinder body through one neck ring and then transferred to the other frame through the other neck ring. Preferably, short longitudinal beams are arranged on both frames for local reinforcement. Therefore, the deadweight of the tank container is reduced through simplifying the structure of the frame assembly.

In addition, Finite Element Analysis method is adopted to simulate the stress condition of the tank container during utilization, for checking whether every local structure of said tank container can meet the requirement on the material's allowable stress under various loadings in accordance with relevant standards and criterions. The safeness of the tank container according to the invention is verified.

In general, according to the present invention, the tank and the tank container is designed by stress analysis methods with simulating practical loading conditions, wherein, the thickness of the cylinder body of the tank is designed and calculated in accordance with a safety factor stipulated in Chinese Technical Standard JB4732 that is for fixed pressurized Vessel. Finite Element Analysis method is also used to simulate the loading condition of the tank, as well as the tank container, in order to ensure the allowable stress limit of the material do not be exceeded. The problem of the prior art that the decrease in deadweight will definitely cause a decrease in safeness is therefore solved.

### BRIEF DESCRIPTION OF THE DRAWINGS

The above and other features and advantages of the present invention will become more evident from the detailed description of the preferred but not exclusive embodiment illustrated indicatively in the accompanying drawings wherein:

FIG. 1 is a front elevational view of a tank container for liquefied gas transportation and storage according to the prior art;

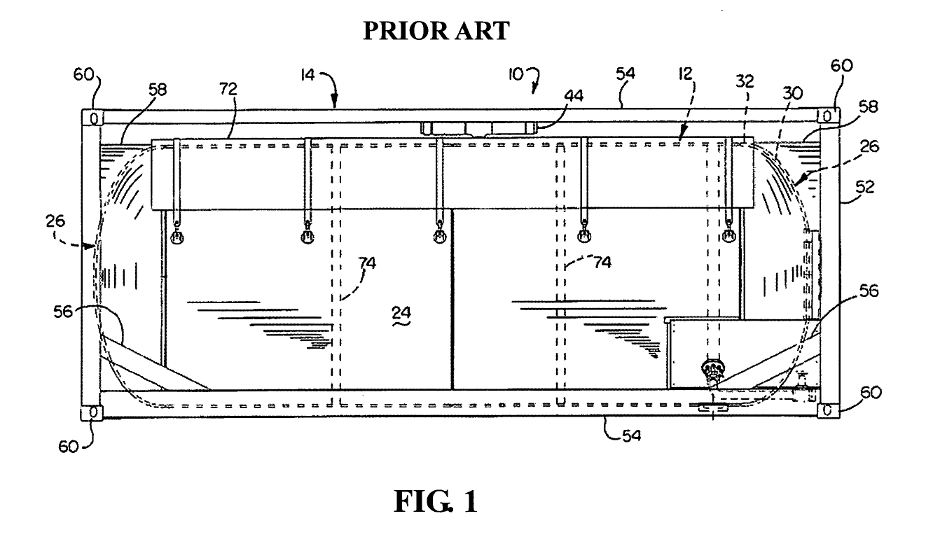

FIG. 2 is a front elevational view of a ultra-light tank container for liquefied gas transportation and storage according to the present invention, showing neck rings welded between the heads of the tank and the corresponding frames to connect the tank and the frames, and having a diameter less than that of the cylinder body of the tank;

FIG. 3 is a side elevational view of the container in FIG. 2;

FIG. 4 is a top elevational view of the container in FIG. 2, showing short longitudinal beams arranged on both frames for connecting locally with the tank;

FIG. 5 is a separate unit view for stress analysis of the tank container according to the present invention.

### DETAILED DESCRIPTION OF THE PREFERRED EMBODIMENT

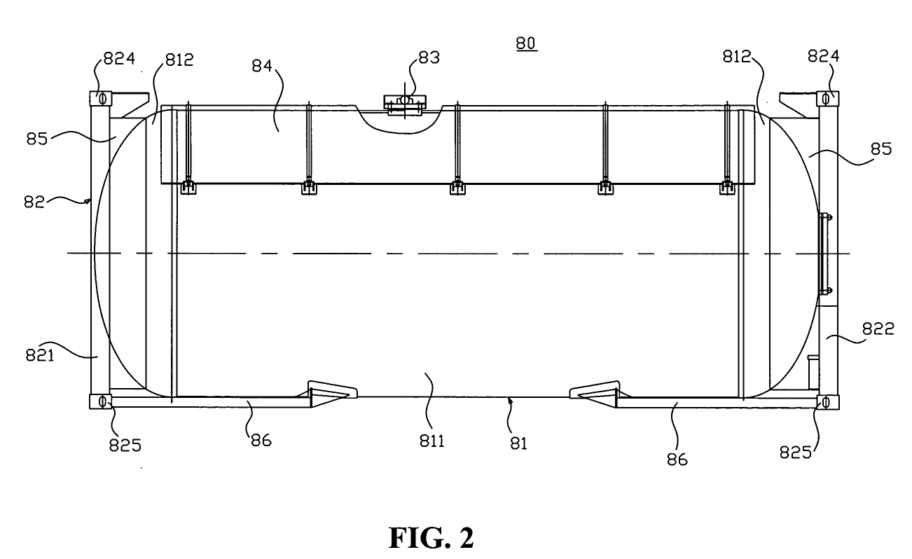

As shown in FIG. 2, according to the present invention, a tank container 80 for transporting liquefied gas includes a tank 81 and a frame assembly 82 for fixing and supporting the tank 81. The tank 81 includes a cylinder body 811 and two heads 812 welded respectively on opposite ends of said cylinder body 811. The frame assembly 82 includes two individual frames, that is, a front frame 821 and a rear frame 822 disposed close to two ends of the tank 81 respectively. The tank 81 and the frame assembly 82 are connected together through neck rings 85 being welded between the heads 812 and corresponding front and rear frames 821 and 822. Said neck ring 85 has a diameter less than that of the cylinder body 811. A safety attachment 83 is arranged on the tank 81 to secure the cargos in the tank. An adumbral plate 84 is preferably mounted on the tank 81 to reduce the rising of the temperature in the tank. Preferably, short longitudinal beams 86 are arranged on both the front frame 821 and the rear frame 822, in order to connect the front and rear frames locally with the tank 81 respectively.

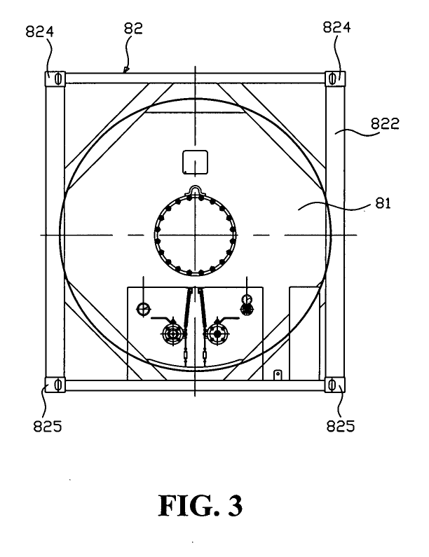

According to the present invention, the front frame 821 is equipped with two top corner members 824 for fastening and hoisting at its two top corners and with two bottom corner members 825 for stacking and hoisting at its two bottom corners. Similarly, the rear frame 822 is also equipped with two top corner members 824 for fastening and hoisting at its two top corners and with two bottom corner members 825 for stacking and hoisting at its two bottom corners, which can be seen clearly in FIG. 3.

As shown in FIGS. 2, 3 and 4, the deadweight of the container 80 according to the present invention is mainly determined by the weight of the tank 81, the frame assembly 82, the neck rings 85, and the short longitudinal beams 86 for local supporting. Since the tank 81 should be loaded with pressurized liquefied gas, steel plates thicker than the structure of the frame 82 are used to manufacture the cylinder body 811 and the heads 812 of the tank. Thus, the weight of the tank 81 takes the main part of the deadweight of the whole container. Moreover, the outer diameter of the cylinder body 811 should be within the maximum width of the frame assembly 82, and the inner diameter Di of the cylinder body 811 determines the volume for loading cargos, therefore the shell thickness δ of the cylinder body 811 becomes the most important parameter that affect the deadweight of the tank.

It is noteworthy that above-mentioned and other standards for calculating the shell thickness is not permanent and are subject to change from time to time. According to the present invention, the shell thickness δ of the cylinder body 811 of the portable container 80 is designed and calculated on the basis of the calculation method for fixed container with a safety factor Kₛ not larger than 2.6, i.e.,

δ=P_{c}×Dᵢ/(2σ_{b}/Kₛ−P_{c}) (*)

where
P_{c} is the calculated pressure;
Dᵢ is the inner diameter of the cylinder body;
σ_{b} is the maximum tensile strength of material of the cylinder body at a normal temperature; and
Kₛ is the safety factor that is no larger than 2.6.

In the U.S. Pat. No. 6,012,598, the shell thickness Tₛ of the cylinder body is substantially equal to P Rᵢ/(⅓Sᵤ−0.5P), which is equivalent to the calculation of the present invention P_{c}×Dᵢ/(2_{b}/Kₛ−P_{c}) with the safety factor Kₛ of 3. In an embodiment of the invention, the material of the cylinder body has a maximum tensile strength of 80,000 psi (552 MPa) while the tank is designed to transport liquefied gas under 27.5BAR and have a volume of 22.5 cubic meters. The shell thickness of the cylinder body calculated through the equation (*) of the present invention with a safety factor Kₛ of 2.6 is less than that calculated through the equation disclosed in the U.S. Pat. No. 6,012,598 by 2.43 mm, with the deadweight of the tank reduced by 625 kg. With a safety factor Kₛ of 2.5, the shell thickness according to the invention is less than that according to the U.S. Pat. No. 6,012,598 by 3.08 mm, with the deadweight of the tank reduced by 792 kg. And with a safety factor Kₛ of 2.4, the shell thickness according to the invention is less than that according to the U.S. Pat. No. 6,012,598 by 3.64 mm, with the deadweight of the tank reduced by 936 kg.

According to the U.S. Pat. No. 6,012,598, the material for the cylinder body is required to have a maximum tensile strength larger than 80,000 psi (552 MPa); while in the present invention, the material, for the cylinder body is required to have a maximum tensile strength no less than 470 MPa. Thus the material range for selection becomes larger.

As disclosed in the U.S. Pat. No. 6,012,598, the shell of the head should be thicker than that of the cylinder body. On the contrary, according to the present invention, the head 812 is designed by using an ellipticity of 1:1.9 and stress analysis method, so that the calculated thickness of the head 812 is less than or equal to the shell thickness of the cylinder body 811. Therefore, the deadweight of the tank 81 is further reduced through reducing the thickness of the head 812. For example, in the above-mentioned embodiment of the invention, the thickness of the head according to the invention can be less than that according to the U.S. Pat. No. 6,012,598 by 2.84 mm, so that the deadweight of the tank can be further reduced.

As disclosed in the U.S. Pat. No. 6,012,598, the connection of the tank and the frame is realized by welding with neck rings of the same diameter as that of the cylinder body. According to the embodiment of the present invention shown in FIG. 2, the connection of the tank 81 and the frames 821, 822 is realized through welding the neck rings 85 between the heads 812 of the tank and corresponding front and rear frames 821 and 822. Since the neck ring 85 has a diameter less than that of the cylinder body 811 of the tank 811, the deadweight of the container 80 can be reduced by reducing the weight of the neck ring 85.

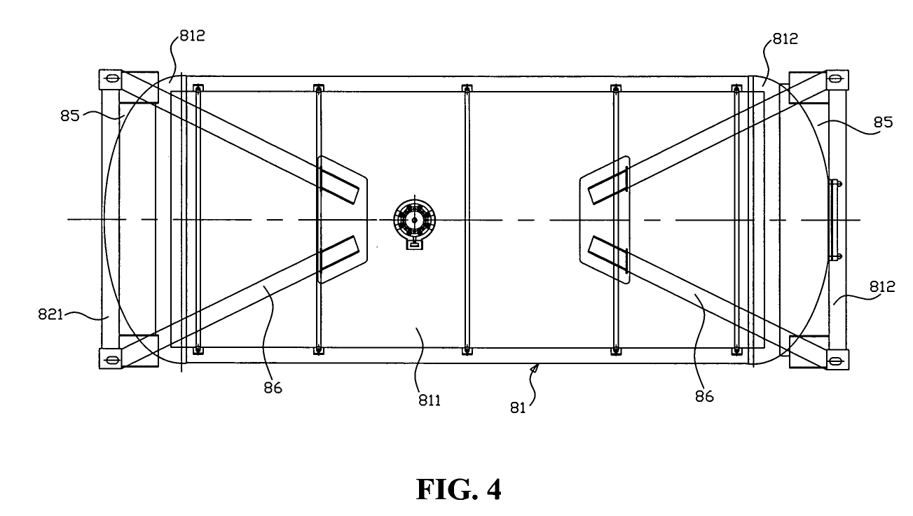

As disclosed in the U.S. Pat. No. 6,012,598, two upper and two lower rails connect directly the two ends of the frame in order to transfer loads. As shown in FIG. 4, according to the invention, the tank 81 is designed as a load transferring member. In particular, the load between the front and rear frames 821 and 822 is transferred through two neck rings 86 and the tank 81. Two short longitudinal beams 86 are extended from the bottom portion of each of the frames 821, 822 and connected to the predetermined portions on the bottom of said tank 81 respectively for supporting and strengthening. Of course, only one or more than two short longitudinal beams 86 can be arranged on either front or rear frames. Thus, the supporting structure of the frame assembly 82 is simplified and the deadweight of the tank container is therefore reduced.

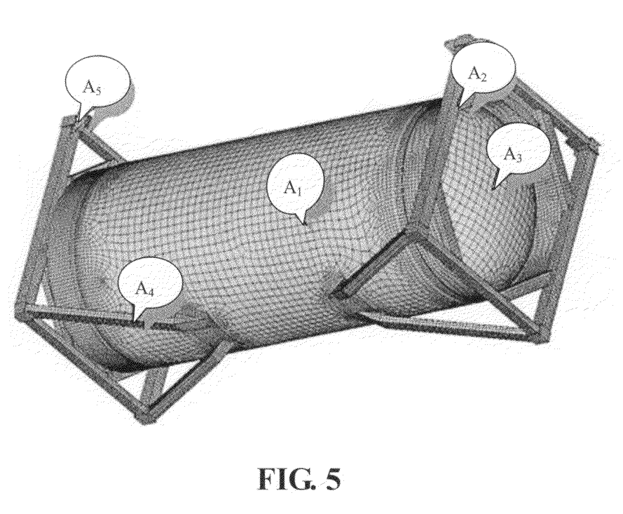

To verify the technical safeness of the tank container 80, Finite Element Analysis (FEA) is used. As shown in FIG. 5, the tank container 80 is separate into a plurality of units for stress analysis. The ANSYS software for FEA is used to simulate the stress situations under various loadings (including dynamic loadings) during the transportation. The structure of the container 80 is being adjusted, until the stress at every position of the container is within the allowable stress of the material used. It should note that the maximum stress point may change under different loadings, for example, among the ranges A₁ to A₅, wherein A₁ indicates the center area of the cylinder body, A₂ indicates the upper transverse beam area of the frame, A₃ indicates the center area of the end sealing member, A₄ indicates the short longitudinal beam area, and A₅ indicates the top corner member area.

For example, in the case that the maximum tensile strength of the material of cylinder body is 80,000 psi while the tank is designed to transport 27.5BAR liquefied gas and have a volume of 22.5 cubic meters, the maximum stress point of the tank container will be in the top corner member area A₅ under the stacked loadings, in the center area A₁ of the cylinder body under the hoisting loadings, in the short longitudinal beam area A₄ under the outer longitudinal fastening loadings, or in the center area A₁ of the cylinder body under the pressure testing loadings.

The technical safeness of the present invention has been verified through the experimental test approved by the competent authority in China.

It is understandable that the portable tank 81 of the present invention should not be limited to the application of tank container, which can be also fixed on a chassis of a vehicle through a frame structure similar to the frame assembly 82 or the like to form a tank vehicle.

Although several preferred embodiments of the present invention have been described, the present invention may be used with other configurations. It will be appreciated by those skilled in the art that, the present invention could have many other embodiments, and changes and modifications may be made thereto without departing from the invention in its broader aspects and as set forth in the following claims and equivalents thereof.

What is claimed is:

1. A portable tank for transporting and storing liquefied gas, including a cylinder body and two heads arranged oppositely and connected with both ends of the cylinder body respectively, wherein the cylinder body has a shell thickness a calculated through stress analysis design methods for fixed containers, and substantially equal to:
P_{c}×Dᵢ/(2σ_{b}/Kₛ−P_{c})
where
P_{c} is the calculated pressure of the tank, required by the transported liquefied gas,
Dᵢ is the inner diameter of the cylinder body,
σ_{b} is the maximum tensile strength of material of the cylinder body at a normal temperature, and
Kₛ is a safety factor that is not larger than 2.6.

2. The tank according to claim 1, wherein the safety factor Ks is taken as 2.5.

3. The tank according to claim 1, wherein the safety factor Ks is taken as 2.4.

4. The tank according to claim 1, wherein the safety factor Ks is taken as 2.6.

5. The tank according to claim 1, wherein the shell thickness of the head is less than or equal to that of the cylinder body.

6. The tank according to claim 1, wherein the maximum tensile strength σ_{b} of the material of the tank is no less than 470 MPa.

7. A tank container for transporting and storing liquefied gas, including:
a tank, including a cylinder body and two heads arranged oppositely and connected with both ends of the cylinder body respectively; and
a frame assembly for fixing and supporting said tank, including a front frame and a rear frame fixed at both ends of said tank respectively,
wherein, the cylinder body has a shell thickness δ substantially equal to
P_{c}×Dᵢ/(2σ_{b}/Kₛ−P_{c})
where
P_{c} is the calculated pressure of the tank, required by the transported liquefied gas,
Dᵢ is the inner diameter of the cylinder body,
σ_{b} is the maximum tensile strength of material of the cylinder body at a normal temperature, and
Kₛ is a safety factor that is not larger than 2.6.

8. The tank container according to claim 7, wherein the safety factor Ks is taken as 2.5.

9. The tank container according to claim 7, wherein the safety factor Ks is taken as 2.4.

10. The tank container according to claim 7, wherein the safety factor Ks is taken as 2.6.

11. The tank container according to claim 7, wherein the shell thickness of the head is larger than or equal to that of the cylinder body.

12. The tank container according to claim 7, wherein the maximum tensile strength σ_{b} of the material of said tank is no less than 470 MPa.

13. The tank container according to claim 7, wherein each of said front and rear frames is welded with one corresponding head of said tank through a neck ring having a diameter less than that of the cylinder body, so that the load between said front and rear frames is transferred through said tank and said neck rings.

14. The tank container according to claim 13, further including a plurality of short longitudinal beams that are extended from the bottoms of said front and rear frames and connected to the predetermined portions on the bottom of said tank, respectively.
